(19) United States
(12) Patent Application Publication
(10) Pub. No.: US 2012/0300612 A1
(43) Pub. Date: Nov. 29, 2012

(54) COMMUNICATION APPARATUS, COMMUNICATION METHOD, AND COMMUNICATION SYSTEM

(75) Inventors: Takeshi Itagaki, Saitama (JP); Hideki Iwami, Saitama (JP); Tomoya Yamaura, Tokyo (JP); Osamu Yoshimura, Kanagawa (JP); Chihiro Fujita, Kanagawa (JP)

(73) Assignee: Sony Corporation, Tokyo (JP)

(21) Appl. No.: 13/462,352

(22) Filed: May 2, 2012

(30) Foreign Application Priority Data
May 25, 2011 (JP) 2011-116808

(51) Int. Cl. H04L 29/14; H04L 12/24

(52) U.S. Cl. 370/216

(57) ABSTRACT

There is provided a communication apparatus including a communication unit that receives first communication data transmitted from a transmitting apparatus to a first receiving apparatus through unicast and second communication data transmitted from the transmitting apparatus to a second receiving apparatus, respectively and a processing unit that processes processing data included in the received first communication data and second communication data. When there is missing data in either of first processing data included in the first communication data and second processing data included in the second communication data, the processing unit executes processing using the other processing data in which there is no missing data, and the processing unit does not make the communication unit transmit a reply with respect to external apparatuses.

### BACKGROUND

The present disclosure relates to a communication apparatus, a communication method, and a communication system.

Currently, applications and services that enable transmission and reception of content data between apparatuses through networks such as the Internet or a local area network (LAN) have been used.

Among them, technology for transmitting image data with a low delay amount has been developed. Technology for decreasing a delay amount and efficiently executing processing when image data using a line base codec is transmitted has been suggested (for example, refer to Japanese Laid-Open Patent Publication No. 2008-28541).

### SUMMARY

As methods of transmitting data between the apparatuses forming the network, “unicast,” in which a transmitting apparatus transmitting data transmits data to a specific apparatus, and “multicast,” in which a transmitting apparatus transmits data to a plurality of apparatuses, are exemplified. In this case, when the transmitting apparatus transmits data wirelessly to one or more apparatuses, if the transmitting apparatus transmits the data to each apparatus through unicast, the number of apparatuses that can transmit data is limited due to a limitation in a data transmittable band. Meanwhile, if the transmitting apparatus transmits data through multicast, the transmitting apparatus can transmit the data to a larger number of apparatuses, compared to when the transmitting apparatus transmits the data through unicast. However, when the transmitting apparatus transmits the data through multicast, data is not retransmitted to only a specific apparatus. For this reason, when the transmitting apparatus transmits the data through multicast, there is an apparatus that does not receive data normally. As a result, when the transmitting apparatus transmits the data through multicast, data may not be stably transmitted.

Therefore, there has been a demand for a communication system in which data can be stably received by a large number of apparatuses when the transmitting apparatus transmits the data wirelessly.

According to the present disclosure, there is provided a communication apparatus including a communication unit that receives first communication data transmitted from a transmitting apparatus to a first receiving apparatus through unicast and second communication data transmitted from the transmitting apparatus to a second receiving apparatus, respectively, and a processing unit that processes processing data which can be included in the received first communication data and second communication data. When there is missing data in either of first processing data included in the first communication data and second processing data included in the second communication data, the processing unit may execute processing using the other processing data in which there is no missing data, and the processing unit does not make the communication unit transmit a reply with respect to external apparatuses.

Moreover, according to the present disclosure, there is provided a communication method including receiving first communication data transmitted from a transmitting apparatus to a first receiving apparatus through unicast and second communication data transmitted from the transmitting apparatus to a second receiving apparatus, and processing processing data which can be included in the received first communication data and second communication data. In the processing step, when there is missing data in either of first processing data included in the first communication data and second processing data included in the second communication data, processing may be executed using the other processing data in which there is no missing data, and a reply with respect to external apparatuses is not transmitted.

Moreover, according to the present disclosure, there is provided a communication system including a transmitting apparatus, a first receiving apparatus that communicates with the transmitting apparatus, a second receiving apparatus that communicates with the transmitting apparatus, and a communication apparatus that receives first communication data transmitted from the transmitting apparatus to the first receiving apparatus through unicast and second communication data transmitted from the transmitting apparatus to the second receiving apparatus, respectively. The communication apparatus may include a communication unit that receives the first communication data and the second communication data, respectively and a processing unit that processes processing data which can be included in the received first communication data and second communication data, and when there is missing data in either of first processing data included in the first communication data and second processing data included in the second communication data, the processing unit may execute processing using the other processing data in which there is no missing data, and the processing unit does not make the communication unit transmit a reply with respect to external apparatuses.

According to the embodiments of the present disclosure described above, data can be stably received by a plurality of apparatuses.

### BRIEF DESCRIPTION OF THE DRAWINGS

FIG. 1 is a diagram illustrating an example of transmission data transmitted by a transmitting apparatus according to an embodiment of the present disclosure;

FIG. 2 is a diagram illustrating an example of transmission data transmitted by the transmitting apparatus according to the embodiment;

FIG. 3 is a diagram illustrating an example of a configuration of a communication system according to the embodiment;

FIG. 4 is a diagram illustrating an example of processing in the communication system according to the embodiment;

FIG. 5 is a diagram illustrating a method of managing sequence numbers in a MAC layer in a communication apparatus according to the embodiment;

FIG. 6 is a diagram illustrating another example of the processing in the communication system according to the embodiment;

FIG. 7 is a diagram illustrating another example of the configuration of the communication system according to the embodiment;

FIG. 8 is a block diagram illustrating an example of a configuration of the communication apparatus according to the embodiment; and

FIG. 9 is a diagram illustrating an example of a hardware configuration of the communication apparatus according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

1. Communication Method according to Embodiment
2. Communication System according to Embodiment
3. Communication Apparatus according to Embodiment
4. Program according to Embodiment.

### (Communication Method According to Embodiment)

Before describing configurations of apparatuses forming a communication system according to the embodiment, a communication method according to the embodiment will be described. Hereinafter, the case in which a communication system according to the embodiment (in detail, the apparatuses forming the communication system according to the embodiment) executes processing relating to the communication method according to the embodiment will be described.

As described above, when a transmitting apparatus transmits data wirelessly to one or more apparatuses, if the transmitting apparatus transmits the data to each apparatus through unicast, there is a limitation in the number of apparatuses that can transmit data. If the transmitting apparatus transmits data through multicast, the data is not retransmitted to only a specific apparatus. For this reason, there are apparatuses that do not receive the data normally.

In this case, as one method by which data can be stably received by a large number of apparatuses when the transmitting apparatus transmits the data wirelessly, for example, a method by which the transmitting apparatus constantly transmits the same data (or packet data obtained by packetizing the data) through multicast several times is considered. As such, if the transmitting apparatus constantly transmits the same data through multicast several times, the possibility of the apparatuses not receiving the data normally existing can be decreased. Therefore, if the transmitting apparatus transmits the same data through multicast several times, data may be stably received by a large number of apparatuses.

However, when the transmitting apparatus transmits the same data through multicast several times, a longer time than that necessary when transmission is performed once may be required. For this reason, when the transmitting apparatus transmits the same data through multicast several times, transmission efficiency of data from the transmitting apparatus to apparatuses of data transmission objects is lowered.

### [Outline of Communication Method According to Embodiment]

In the communication system according to this embodiment, an apparatus transmitting transmission data (hereinafter referred to as a “transmitting apparatus 100”) transmits transmission data to one apparatus (hereinafter referred to as a “first receiving apparatus”) that is a wireless transmission object of the transmission data through unicast. The transmitting apparatus 100 transmits the transmission data to one or more apparatuses (hereinafter referred to as a “second receiving apparatus”) that are other wireless transmission objects of the transmission data through unicast or multicast. In this case, when the transmitting apparatus 100 transmits the transmission data to one second receiving apparatus, the transmitting apparatus 100 transmits the transmission data through unicast or multicast. When the transmitting apparatus 100 transmits the transmission data to a plurality of second receiving apparatuses, the transmitting apparatus 100 transmits the transmission data through multicast. Hereinafter, a communication path of wireless communication between the transmitting apparatus 100 and the first receiving apparatus is referred to as a “first communication path” and a communication path of the wireless communication different from the first communication path between the transmitting apparatus 100 and the first receiving apparatus is referred to as a “second communication path.” In the communication system according to the embodiment, the transmitting apparatus that transmits the transmission data using the first communication path and the transmitting apparatus that transmits the transmission data using the second communication path may be the same transmitting apparatus or may be separate apparatuses.

In this case, content data (or data including the content data) that shows an image (a moving image or a still image) and/or a sound (including music) is exemplified as the transmission data according to the embodiment. Hereinafter, the image and/or the voice is generally called “content.” The transmission data according to this embodiment is not limited to the content data. For example, various data (or data including the various data) such as text data, update data to update an application, and control data to control software or hardware are exemplified as the transmission data according to this embodiment.

Another communication apparatus (hereinafter referred to as a “communication apparatus 300”) other than the first receiving apparatus and the second receiving apparatus (hereinafter, generally referred to as a “receiving apparatus 200”) that form the communication system according to this embodiment is typically disposed at a position (in a communication area of the transmitting apparatus 100) at which the communication data transmitted from the transmitting apparatus 100 can be received and receives the communication data transmitted and received between the transmitting apparatus 100 and the receiving apparatus 200 (reception processing of the communication data). The communication apparatus 300 determines data used in processing (hereinafter referred to as “processing data”) from the received communication data (determination processing of the processing data). In this case, because the communication apparatus 300 sets the transmission data transmitted from the transmitting apparatus 100 as a processing object, the communication data that is transmitted from the transmitting apparatus 100 may be received or the communication data that is transmitted from the receiving apparatus 200 may not be received. Because the communication apparatus 300 can determine the processing data by executing the determination processing of the processing data, the communication apparatus 300 can process the determined processing data normally, even when the communication data transmitted from the receiving apparatus 200 is received. Hereinafter, the case in which the communication apparatus 300 can receive the communication data transmitted and received between the transmitting apparatus 100 and the receiving apparatus 200 will be described.

Specifically, even when the communication apparatus 300 receives the communication data (hereinafter referred to as “first communication data”) transmitted and received between the transmitting apparatus 100 and the first receiving apparatus and the destination (transmission destination) of the received first communication data is not a self apparatus, the communication apparatus 300 determines the data used in the processing from the received first communication data. Even when the communication apparatus 300 receives the communication data (hereinafter referred to as “second communication data”) transmitted and received between the transmitting apparatus 100 and the second receiving apparatus and the destination (transmission destination) of the received second communication data is not a self apparatus, the communication apparatus 300 determines the data used in the processing from the received second communication data. That is, when the destination (transmission destination) of the received communication data is not the self apparatus, a general apparatus that performs the unicast communication discards the communication data. Meanwhile, even when the destination (transmission destination) of the received communication data is not the self apparatus, the communication apparatus 300 does not discard the communication data (a part of the communication data) without determining the data used in the processing.

In this case, the transmission data transmitted from the transmitting apparatus 100 and a reply signal (reply data) transmitted from the receiving apparatus 200 are exemplified as the first communication data and the second communication data according to the embodiment (hereinafter, generally referred to as “communication data”). As the reply signal according to the embodiment, an acknowledgement (ACK) and a negative acknowledgement (NACK) are exemplified.

As a method of determining the processing data in the communication apparatus 300, a method by which the communication apparatus 300 determines the processing data on the basis of a specific identifier, which can be included in the received communication data, is exemplified.

Specifically, the communication apparatus 300 detects a specific identifier from the received communication data. When the specific identifier is detected, the communication apparatus 300 determines a payload of the received communication data as the processing data. When the specific identifier is not detected, the communication apparatus 300 discards the received communication data. In this case, the specific identifier may function as a group ID that shows a transmission object of data.

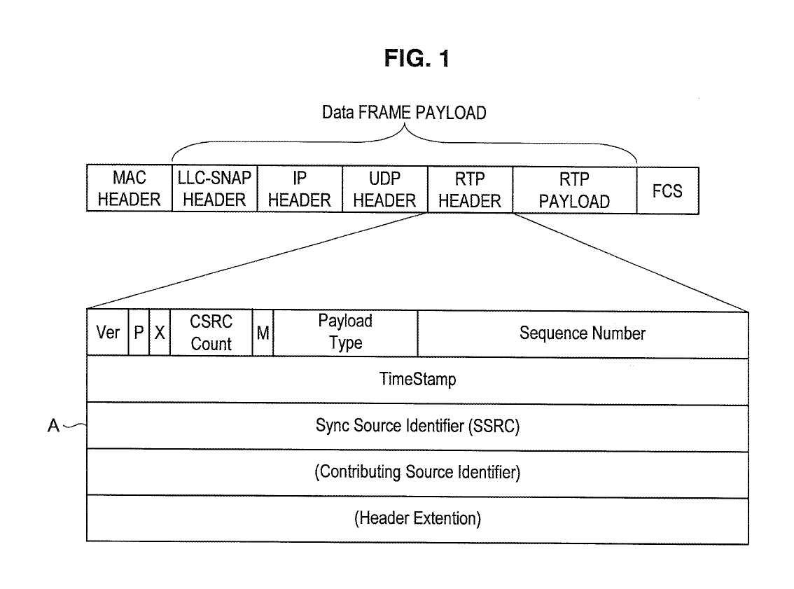

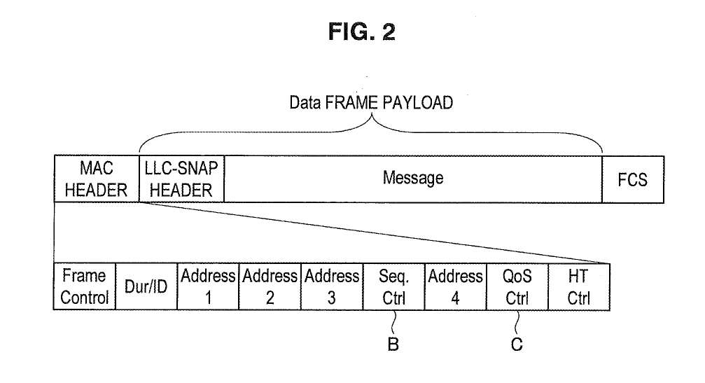

FIGS. 1 and 2 are diagrams illustrating an example of the transmission data transmitted by the transmitting apparatus 100 according to the embodiment. FIGS. 1 and 2 illustrate an example of a data packet of transmission data when the transmitting apparatus 100 transmits transmission data through wireless communication based on a wireless LAN of IEEE802.11 series.

The communication apparatus 300 according to the embodiment detects a synchronization source (SSRC) field of a real-time transport protocol (RTP) header illustrated by A of FIG. 1 as the specific identifier. The specific identifier that is detected by the communication apparatus 300 according to the embodiment is not limited to the SSRC field. For example, the communication apparatus 300 may detect a combination of a plurality of fields such as a combination of a field of a transmission source address included in a field illustrated by B of FIG. 2 and a traffic ID (TID) field of a medium access control address (MAC) included in a field illustrated by C of FIG. 2 as the specific identifier. When the first communication path and/or the second communication path is a path of the wireless communication based on the wireless LAN of the IEEE802.11 series, the communication apparatus 300 may detect a field provided in a basic service set identifier (BSSID) as the specific identifier. The communication apparatus 300 can use identification information showing the specific identifier to detect the identifier shown by the identifier information from the communication data. In this case, the identifier information may be stored in a storage unit (to be described below) in advance or the communication apparatus 300 may acquire the identifier information from an external apparatus such as a server.

As described above, if the processing data is determined, the communication apparatus 300 processes the processing data, which can be included in the received first communication data and second communication data, on the basis of the determination result of the data (processing for processing the processing data).

Specifically, when there is missing data (abnormally received data; hereinafter referred to as “missing data”) in either of data (hereinafter referred to as “first processing data”) determined as the data used in the processing from the first communication data and data (hereinafter referred to as “second processing data”) determined as the data used in the processing from the second communication data, the communication apparatus 300 executes the processing using the other processing data where there is no missing data. That is, even when there is missing data in one of the first processing data and the second processing data, the communication apparatus 300 replaces the missing data with the other processing data and executes the processing.

The communication apparatus 300 does not transmit a reply (for example, transmit a reply signal) according to reception of the communication data to the external apparatuses such as the transmitting apparatus 100 and the receiving apparatus 200.

The communication apparatus 300 according to the embodiment executes (1) reception processing, (2) determination processing of processing data, and (3) processing for processing the processing data as the processing relating to the communication method according to the embodiment. When the communication apparatus 300 executes the processing of (1) to the processing of (3), the communication apparatus 300 does not transmit the reply to the external apparatuses such as the transmitting apparatus 100 and the receiving apparatus 200.

As such, in the communication system according to the embodiment, each of one or more communication apparatuses 300 receives the first communication data transmitted and received through unicast using the first communication path and the second communication data transmitted and received using the second communication path even when the destination (transmission destination) is not the self apparatus and executes the processing based on the received communication data. That is, in the communication system according to the embodiment, the unicast wireless communication is not performed between the transmitting apparatus 100 and the communication apparatus 300 or between the receiving apparatus 200 and the communication apparatus 300. Therefore, in the communication system according to the embodiment, when the wireless communication is performed using a certain band, data can be transmitted to a larger number of communication apparatuses 300, compared to when the transmitting apparatus transmits the data wirelessly to each apparatus through unicast (hereinafter referred to as “conventional unicast wireless communication”).

Because each communication apparatus 300 receives the communication data transmitted and received through unicast between the transmitting apparatus 100 and the first receiving apparatus, the transmitting apparatus 100 can receive the transmission data retransmitted to the first receiving apparatus (specific apparatus). Therefore, the communication system according to the embodiment can further decrease the possibility of there being apparatuses that do not receive data normally, compared to when the transmitting apparatus transmits data wirelessly to each apparatus through multicast (hereinafter referred to as “conventional multicast wireless communication”).

Even when the destination (transmission destination) of the received transmission data is not the self apparatus, the communication apparatus 300 determines data used in the processing, from each of the received first communication data and the received second communication data. Even when the first communication data is not received normally and missing data is generated in the first processing data (an example of one processing data), the communication apparatus 300 replaces the missing data with the second processing data (an example of the other processing data) and executes the processing. Therefore, the communication apparatus 300 can process the processing data normally, even when the communication apparatus 300 does not transmit the reply (for example, retransmission request) according to the reception of the communication data to the external apparatuses such as the transmitting apparatus 100 and the receiving apparatus 200.

Accordingly, in the communication system according to the embodiment, if the communication apparatus 300 executes the processing relating to the communication method according to the embodiment, band use efficiency can be further improved compared to when the conventional unicast wireless communication or the conventional multicast wireless communication is used and data can be stably received by a large number of apparatuses.

Hereinafter, an example of a configuration of the communication system according to the embodiment and a specific example of the processing relating to the communication method according to the embodiment will be described. An example of a configuration of the communication apparatus 300 that executes the processing relating to the communication method according to the embodiment will be described below.

### (Communication System According to Embodiment)

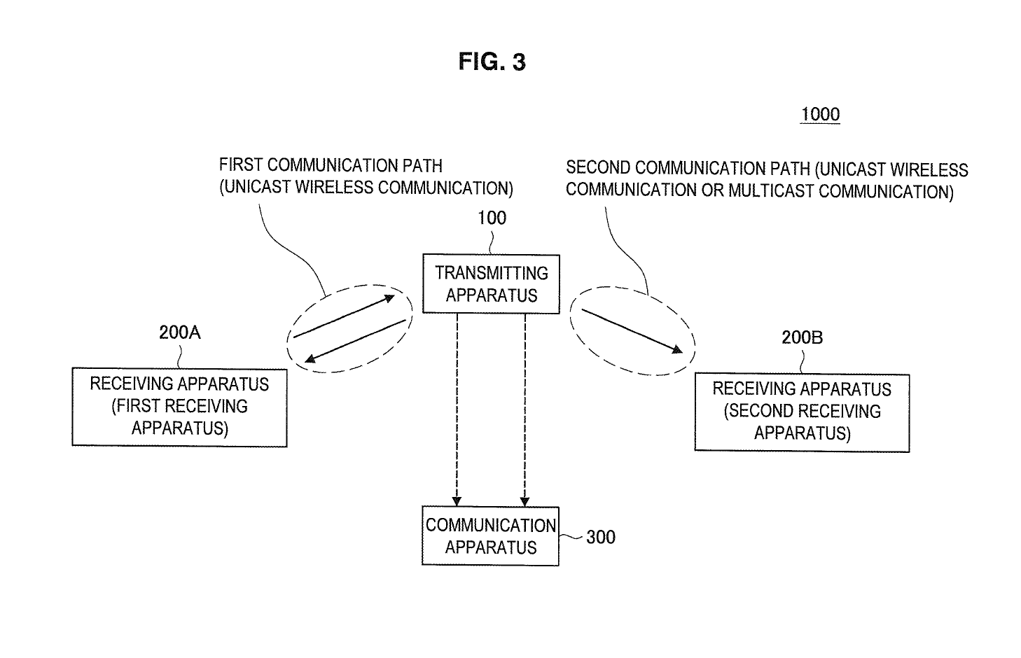

FIG. 3 is a diagram illustrating the example of the configuration of the communication system according to the embodiment. A communication system 1000 illustrated in FIG. 3 includes a transmitting apparatus 100, a receiving apparatus 200A (first receiving apparatus), a receiving apparatus 200B (second receiving apparatus), and a communication apparatus 300. In this case, the communication apparatus 300 is disposed in a communication area of the transmitting apparatus 100, as described above.

FIG. 3 illustrates the configuration in which the communication system 1000 includes one receiving apparatus 200B as a receiving apparatus functioning as the second receiving apparatus. However, the configuration of the communication system according to the embodiment is not limited thereto. For example, when the transmitting apparatus 100 transmits the transmission data through multicast using the second communication path, a plurality of receiving apparatuses may function as the second receiving apparatus in the communication system according to the embodiment. FIG. 3 illustrates the configuration in which the communication system 1000 includes one communication apparatus 300. However, the configuration of the communication system according to the embodiment is not limited thereto. For example, the communication system according to the embodiment may include a plurality of communication apparatuses to execute the processing relating to the communication method according to the embodiment. In the communication system according to the embodiment, with regard to a data transmission direction, an uplink, a downlink, a direct link, and an ad-hoc network may be used. In the communication system according to the embodiment, the receiving apparatus 200A that functions as the first receiving apparatus or the receiving apparatus 200B that functions as the second receiving apparatus can function as the communication apparatus that executes the processing relating to the communication method according to the embodiment. Hereinafter, an example of the processing in the communication system according to the embodiment will be described using the configuration illustrated in FIG. 3.

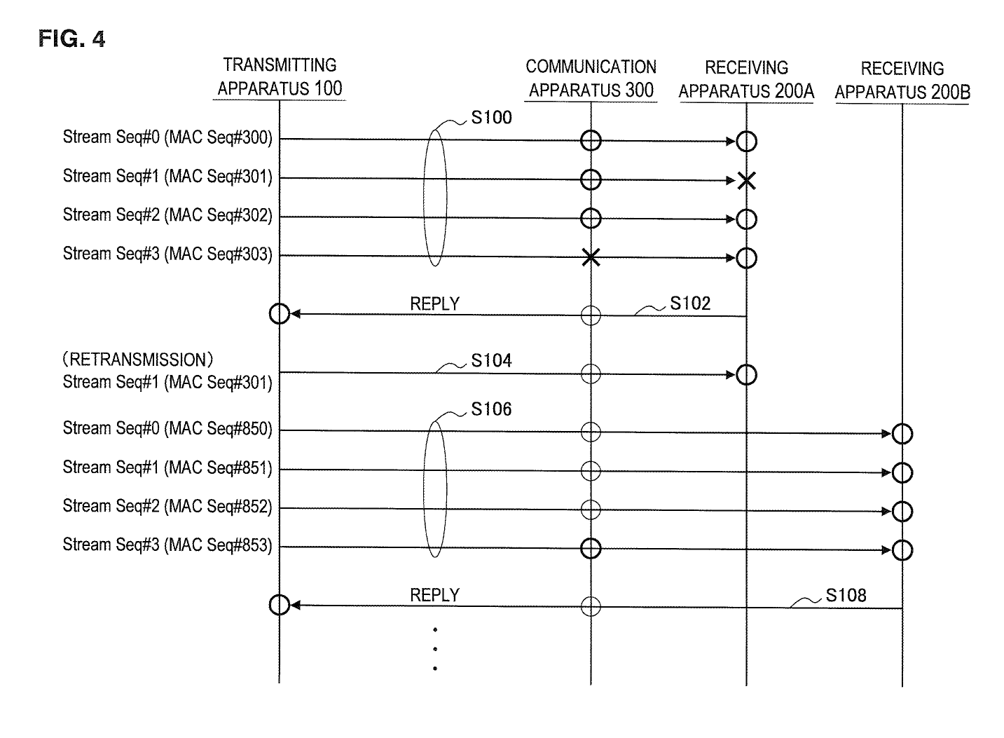

FIG. 4 is a diagram illustrating an example of the processing in the communication system 1000 according to the embodiment. FIG. 4 illustrates the case in which each of the first communication path and the second communication path is a path of the unicast wireless communication.

FIG. 4 illustrates the case in which the transmitting apparatus 100 alternately transmits data frames (hereinafter referred to as “application data frames”) in which a plurality of data packets are coupled to the receiving apparatus 200A (first receiving apparatus) and the receiving apparatus 200B (second receiving apparatus) for each frame. FIG. 4 illustrates an application data frame where in which data packets are coupled. However, the application data frame according to the embodiment is not limited to the example illustrated in FIG. 4. The transmitting apparatus 100 according to the embodiment may not transmit the application data frame but may transmit each data packet. FIG. 4 illustrates an example of the case in which the transmitting apparatus 100 transmits the transmission data in a streaming form (that is, an example of the case in which the transmission data is streaming data).

The transmitting apparatus 100 transmits data packets of sequence numbers (hereinafter referred to as “Stream Seq#”) 0 to 3 of upper layers with respect to a MAC layer to the receiving apparatus 200A through unicast (S100). In this case, application layers on an open systems interconnection (OSI) reference model are exemplified as the sequence numbers of the upper layers. The Stream Seq#0 to 3 transmitted in step S100 correspond to sequence numbers (hereinafter referred to as “MAC sequence numbers” and “MAC Seq#”) 300 to 303 in the MAC layer.

If the packets are transmitted in step S100, the receiving apparatus 200A receives the data packets of the Stream Seq#0 to 3 transmitted in step S100. FIG. 4 illustrates an example of the case in which the receiving apparatus 200A does not receive the data packet of the Stream Seq#1 transmitted in step S100 normally.

The communication apparatus 300 receives the data packets of the Stream Seq#0 to 3 transmitted in step S100 (the processing of (1) (reception processing)) and determines the processing data from the received data packets of the Stream Seq#0 to 3 (the processing of (2) (determination processing of the processing data)). FIG. 4 illustrates an example of the case in which the communication apparatus 300 does not receive the data packet of the Stream Seq#3 transmitted in step S100 normally.

Because the receiving apparatus 200A does not receive the data packet of the Stream Seq#1 normally, the receiving apparatus 200A transmits a reply (for example, transmission of a block ACK including NACK information) to request retransmission of the data packet of the Stream Seq#1 (S102).

If the reply is transmitted in step S102, the communication apparatus 300 receives the reply transmitted in step S102. The communication apparatus 300 does not receive the data packet of the Stream Seq#3 normally. However, the transmitting apparatus 300 does not transmit the reply to the external apparatuses such as the transmitting apparatus and the receiving apparatuses 200A and 200B.

The transmitting apparatus 100 that has received the reply transmitted in step S102 transmits the data packet of the Stream Seq#1 in which the retransmission is requested by the reply, to the receiving apparatus 200A (S104).

If the data packet of the Stream Seq#1 is transmitted in step S104, the receiving apparatus 200A receives the data packet of the Stream Seq#1 transmitted in step S104.

FIG. 4 illustrates an example of the case in which the receiving apparatus 200A can receive the data packet of the Stream Seq#1 transmitted in step S104 normally.

The communication apparatus 300 receives the data packet of the Stream Seq#1 transmitted in step S104 (the processing of (1) (reception processing)) and determines the processing data from the received data packet of the Stream Seq#1 (the processing of (2) (determination processing of the processing data)). FIG. 4 illustrates an example of the case in which the communication apparatus 300 can receive the data packet of the Stream Seq#1 transmitted in step S104 normally.

In this case, when the transmission data is the stream data and technology for gathering packets such as the application data frames is used, if the communication apparatus 300 transmits the received packets to the upper layers (hereinafter, upper layers on the OSI reference model) and executes the processing, order of the data packets may be reversed due to the retransmission. When the order reversal of the data packets is generated, the possibility of the processing data not being processed normally in the communication apparatus 300 is high. For example, when the transmission data is the streaming data showing the contents, overlapping of the reproduced contents may occur. The generation of the order reversal of the data packets is not limited to when the transmission data is the stream data and when the technology for gathering the packets is used. The order reversal of the data packets occurs both when the transmission data is not the stream data and when the technology for gathering the packets is not used. Even when the communication apparatus 300 executes the processing using a protocol relating to real-time transmission of the data such as the RTP, the order reversal of the data packets is generated.

The communication apparatus 300 manages the sequence numbers in the MAC layer (for example, included in a data link layer of the OSI reference model) and prevents the order reversal of the data packets in the processing of (3) (processing for processing the processing data).

Specifically, an example of the case in which the transmission data is stream data will be described. Before reproducing the stream data (corresponding to the determined processing data), the communication apparatus 300 associates MAC sequence numbers in the first communication data and upper layer sequence numbers in upper layers of the MAC layer. Before reproducing the stream data (corresponding to the determined processing data), the communication apparatus 300 associates MAC sequence numbers in the second communication data and upper layer sequence numbers. The association of the MAC layer sequence numbers and the upper layer sequence numbers can be performed in the same manner, even when the communication apparatus 300 according to the embodiment receives communication data of communication paths other than the first communication path and the second communication path.

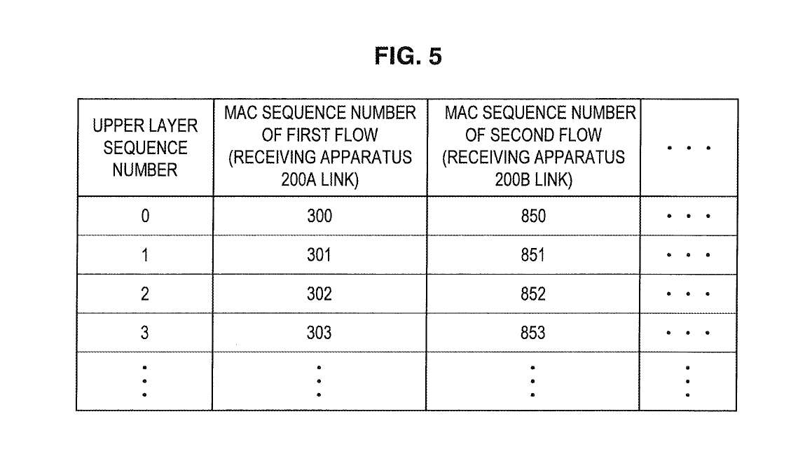

FIG. 5 is a diagram illustrating an example of a method of managing the sequence numbers in the MAC layer in the communication apparatus 300 according to the embodiment. FIG. 5 illustrates the first communication path as a first flow and the second communication path as a second flow. For example, as illustrated in FIG. 5, the communication apparatus 300 associates the MAC sequence numbers in the first communication data and the upper layer sequence numbers and associates the MAC sequence numbers in the second communication data and the upper layer sequence numbers and manages the sequence numbers.

For example, as illustrated in FIG. 5, if the communication apparatus 300 manages the sequence numbers in the MAC layer (MAC sequence numbers), even when the order reversal of the data packets is generated due to the retransmission of the data packets, the communication apparatus 300 refers to the upper layer sequence numbers before transmitting the processing data to the application layers to be the upper layers and can restore the order. For example, as illustrated in FIG. 5, if the communication apparatus 300 manages the sequence numbers in the MAC layer (MAC sequence numbers), even when the overlapped packets are received as illustrated in step S104 of FIG. 4, the communication apparatus 300 refers to the upper layer sequence numbers and can selectively discard the received overlapped packets.

Therefore, as illustrated in FIG. 5, if the communication apparatus 300 manages the sequence numbers in the MAC layer (MAC sequence numbers), the communication apparatus 300 can process the processing data normally while receiving the retransmitted packets.

FIG. 5 illustrates an example of the case in which the communication apparatus 300 associates the MAC layer sequence numbers and the upper layer sequence numbers corresponding to the number of communication paths to receive the communication data, that is, the number of communication paths observed by the communication apparatus 300, and manages the sequence numbers. The method of managing the sequence numbers in the MAC layer in the communication apparatus 300 according to the embodiment is not limited to the example illustrated in FIG. 5. For example, the association of the MAC layer sequence numbers and the upper layer sequence numbers can be gathered in one queue using an arbitrary method of maintaining the association of the MAC layer sequence numbers and the upper layer sequence numbers. As such, when the association is gathered in one queue and is managed, in the communication system 1000 illustrated in FIG. 1, the communication apparatus 300 manages the first processing data and the second processing data in one queue.

As illustrated in FIG. 5, the communication apparatus 300 associates the MAC sequence numbers in the first communication data and the upper layer sequence numbers and associates the MAC sequence numbers in the second communication data and the upper layer sequence numbers. Therefore, as illustrated in FIG. 5, the MAC sequence numbers in the first communication data and the MAC sequence numbers in the second communication data can be associated with each other in a one-to-one relation. If a correspondence relation of the MAC sequence numbers in the first communication data and the MAC sequence numbers in the second communication data is in the one-to-one relation, the communication apparatus 300 refers to the MAC sequence numbers without referring to the upper layer sequence numbers and can replace the missing data.

However, the correspondence relation of the MAC sequence numbers in the first communication data and the MAC sequence numbers in the second communication data is not typically limited to the one-to-one relation. For example, when data packets of beacons or other protocols are transmitted from the transmitting apparatus 100, the correspondence relation of the MAC sequence numbers in the first communication data and the MAC sequence numbers in the second communication data collapses. As such, when the correspondence relation of the MAC sequence numbers in the first communication data and the MAC sequence numbers in the second communication data collapses, it may be impossible to replace the missing data by referring to the MAC sequence numbers.

The communication apparatus 300 selectively corrects the association of the upper layer sequence numbers and the MAC sequence numbers in the first communication data and/or the association of the upper layer sequence numbers and the MAC sequence numbers in the second communication data.

Specifically, when the communication apparatus 300 determines the data not used in the processing from the received first communication data, the communication apparatus 300 corrects the association of the upper layer sequence numbers and the MAC sequence numbers in the first communication data. When the communication apparatus 300 determines the data not used in the processing from the received second communication data, the communication apparatus 300 corrects the association of the upper layer sequence numbers and the MAC sequence numbers in the second communication data. In this case, the correction of the association of the upper layer sequence numbers and the MAC sequence numbers in the first communication data and the correction of the association of the upper layer sequence numbers and the MAC sequence numbers in the second communication data are performed by updating a table illustrated in FIG. 5.

For example, as described above, the communication apparatus 300 can maintain the correspondence relation of the MAC sequence numbers in the first communication data and the MAC sequence numbers in the second communication data as the one-to-one relation, by selectively correcting the association of the upper layer sequence numbers and the MAC sequence numbers. Therefore, because the communication apparatus 300 refers to the MAC sequence numbers without referring to the upper layer sequence numbers and can execute the processing such as the replacement of the missing data, processing time of the processing of (3) (processing for processing the processing data) can be decreased.

Even when the correspondence relation of the MAC sequence numbers in the first communication data and the MAC sequence numbers in the second communication data collapses, the communication apparatus 300 can execute various processing such as the replacement of the missing data, by referring to the upper layer sequence numbers. That is, even when the communication apparatus 300 according to the embodiment does not selectively correct the association of the upper layer sequence numbers and the MAC sequence numbers as described above, the communication apparatus 300 can process the processing data normally.

The communication apparatus 300 executes the processing (processing for processing the processing data) of (3) while managing the MAC sequence numbers, as described above.

Referring to FIG. 4 again, an example of the processing in the communication system 1000 according to the embodiment will be described. If processing of step S104 is executed, the transmitting apparatus 100 transmits the data packets of the Stream Seq#0 to 3 to the receiving apparatus 200B through unicast (S106). In this case, the Stream Seq#0 to 3 transmitted in step S106 correspond to MAC Seq#850 to 853.

If the packets are transmitted in step S106, the receiving apparatus 200B receives the data packets of the Stream Seq#0 to 3 transmitted in step S106. FIG. 4 illustrates an example of the case in which the receiving apparatus 200B can receive all of the data packets transmitted in step S106 normally.

The communication apparatus 300 receives the data packets of the Stream Seq#0 to 3 transmitted in step S106 (the processing of (1) (reception processing)) and determines the processing data from the received data packets of the Stream Seq#0 to 3 (the processing of (2) (determination processing of the processing data)). FIG. 4 illustrates an example of the case in which the communication apparatus 300 can receive all of the data packets transmitted in step S106 normally.

In this case, the communication apparatus 300 receives the data packets of the Stream Seq#0 to 3 in step S100 normally. Therefore, the communication apparatus 300 discards the data packets of the Stream Seq#0, 2, and 3 received in step S106.

The data packet (corresponding to the missing data) of the Stream Seq#1 not received normally in step S100 is received normally by the communication apparatus 300 in step S106. Therefore, when the communication apparatus 300 processes the processing data corresponding to the data packets of the Stream Seq#0 to 3 (when the processing of (3) (processing for processing the processing data) is executed), the communication apparatus 300 completes the processing data corresponding to the data packet of the Stream Seq#1 not received normally in step S100 using the processing data corresponding to the data packet of the Stream Seq#1 received normally in step S106 and executes the processing.

As described above, the communication apparatus 300 associates the MAC sequence numbers in the first communication data and the upper layer sequence numbers and associates the MAC sequence numbers in the second communication data and the upper layer sequence numbers, as illustrated in FIG. 5. Therefore, the communication apparatus 300 specifies the missing data by referring to the table illustrated in FIG. 5 and can replace the specified missing data with the processing data of another communication path.

In this case, the communication apparatus 300 refers to the processing data (first processing data) corresponding to the first flow and the processing data (second processing data) corresponding to the second flow in FIG. 5 and replaces the missing data. However, the processing in the communication apparatus 300 according to the embodiment is not limited thereto. For example, the communication apparatus 300 may use any one of the first processing data and the second processing data as main processing data mainly used in the processing and use the other processing data not to be the main processing data, only when there is missing data in the main processing data. If the communication apparatus 300 executes the processing concentrating on the processing data received using the specific communication path, the communication apparatus 300 can further decrease the processing time of the processing (3) (processing for processing the processing data), compared to when the communication apparatus 300 executes the processing concentrating on the processing data received using all of the communication paths.

Because the receiving apparatus 200B having received the packets transmitted in step S106 can receive all of the data packets transmitted in step S106 normally, the receiving apparatus 200 transmits a reply (for example, transmits a block ACK) indicating that the data packets have been received normally (S108).

If the reply is transmitted in step S108, the communication apparatus 300 receives the reply transmitted in step S108. The communication apparatus 300 can receive all of the data packets of the Stream Seq#0 to 3 transmitted from the transmitting apparatus 100 in steps S100 and S106 normally. However, the communication apparatus 300 does not transmit the reply to the external apparatuses such as the transmitting apparatus 100, the receiving apparatus 200A, and the receiving apparatus 200B.

In the communication system 1000, for example, the processing illustrated in FIG. 4 is executed. In this case, the communication apparatus 300 receives the packets transmitted to the receiving apparatus 200A (first receiving apparatus) in step S100 and the packets transmitted to the receiving apparatus 200B (second receiving apparatus) in step S106 (the processing of (1) (reception processing)). The communication apparatus 300 determines the processing data from the received packets (the processing of (2) (processing for determining the processing data)). The communication apparatus 300 processes the determined processing data (the processing of (3) (processing for processing the processing data)). In this case, the communication apparatus 300 does not transmit a reply (for example, retransmission request or ACK) to any of the transmitting apparatus 100, the receiving apparatus 200A, and the receiving apparatus 200B. When the communication apparatus 300 processes the determined processing data, if there is missing data in the processing data corresponding to the communication data received in one communication path, the communication apparatus 300 replaces the missing data with the processing data corresponding to the communication data received in another communication path. Therefore, the communication apparatus 300 can process the processing data normally, even when a reply (for example, a retransmission request) according to reception of the communication data is not transmitted to the external apparatuses such as the transmitting apparatus 100, the receiving apparatus 200A, and the receiving apparatus 200B.

As such, if the communication apparatus 300 executes the processing of (1) (reception processing) to the processing of (3) (processing for processing the processing data) relating to the communication method according to the embodiment, a communication system by which data can be stably received by a large number of apparatuses is realized.

The processing in the communication system 1000 according to the embodiment is not limited to the processing illustrated in FIG. 4. FIG. 4 illustrates an example of the case in which only the communication apparatus 300 executes the processing relating to the communication method according to the embodiment. However, the receiving apparatus 200A and/or the receiving apparatus 200B can execute the processing relating to the communication method according to the embodiment.

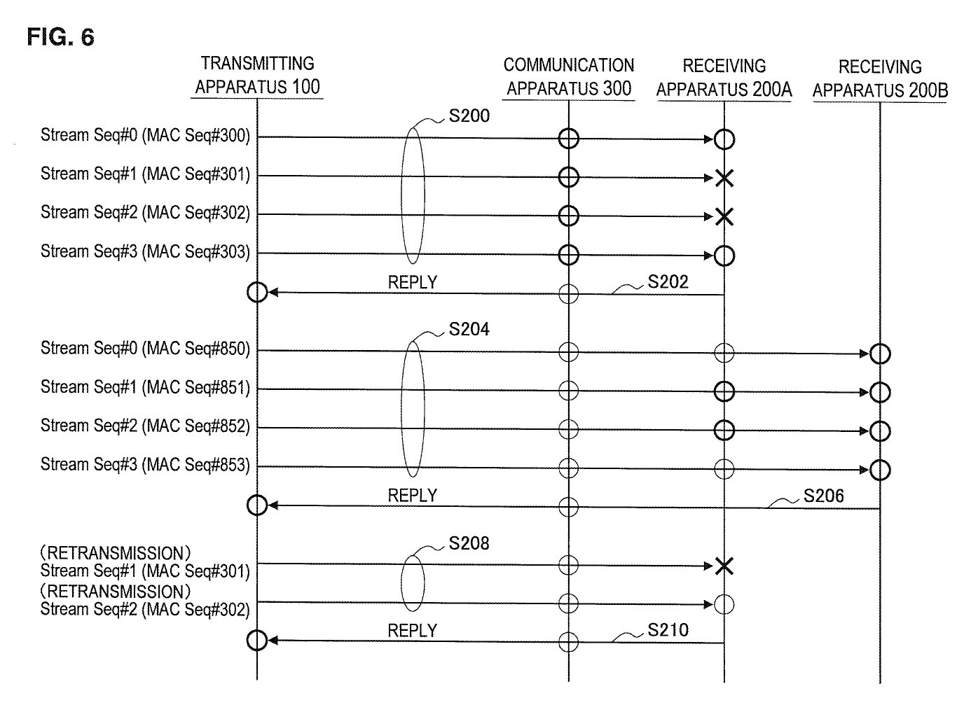

FIG. 6 is a diagram illustrating another example of the processing in the communication system 1000 according to the embodiment. FIG. 6 illustrates an example of the case in which the receiving apparatus 200A (first receiving apparatus) and the communication apparatus 300 execute the processing relating to the communication method according to the embodiment.

FIG. 6 illustrates the case in which the transmitting apparatus 100 alternately transmits application data frames to the receiving apparatus 200A (first receiving apparatus) and the receiving apparatus 200B (second receiving apparatus) for each frame, similar to the processing illustrated in FIG. 4. FIG. 6 illustrates an example of the case in which the transmitting apparatus 100 transmits the transmission data in a streaming form (that is, an example of the case in which the transmission data is streaming data), similar to the processing illustrated in FIG. 4.

The transmitting apparatus 100 transmits the data packets of the Stream Seq#0 to 3 to the receiving apparatus 200A through unicast (S200), similar to step S100 illustrated in FIG. 4.

If the packets are transmitted in step S200, the receiving apparatus 200A receives the data packets of the Stream Seq#0 to 3 transmitted in step S200. FIG. 6 illustrates an example of the case in which the receiving apparatus 200A does not receive the data packets of the Stream Seq#1 and 2 transmitted in step S200 normally.

The communication apparatus 300 receives the data packets of the Stream Seq#0 to 3 transmitted in step S200 (the processing of (1) (reception processing)) and determines the processing data from the received data packets of the Stream Seq#0 to 3 (the processing of (2) (determination processing of the processing data)), similar to step S100 of FIG. 4. FIG. 6 illustrates an example of the case in which the communication apparatus 300 receives all of the data packets transmitted in step S200 normally.

Because the receiving apparatus 200A does not receive the data packets of the Stream Seq#1 and 2 normally, the receiving apparatus 200A transmits a reply (for example, transmission of a block ACK including NACK information) to request retransmission of the data packets of the Stream Seq#1 and 2 (S202).

If the reply is transmitted in step S202, the transmitting apparatus 100 transmits the data packets of the Stream Seq#0 to 3 to the receiving apparatus 200B through unicast (S204), similar to step S106 of FIG. 4.

If the packets are transmitted in step S204, the receiving apparatus 200B receives the data packets of the Stream Seq#0 to 3 transmitted in step S204. FIG. 6 illustrates an example of the case in which the receiving apparatus 200B can receive all of the data packets transmitted in step S204 normally.

The communication apparatus 300 receives the data packets of the Stream Seq#0 to 3 transmitted in step S204 (the processing of (1) (reception processing)) and determines the processing data from the received data packets of the Stream Seq#0 to 3 (the processing of (2) (determination processing of the processing data)), similar to step S106 illustrated in FIG. 4. FIG. 6 illustrates an example of the case in which the communication apparatus 300 can receive all of the data transmitted in step S204 normally.

In this case, the communication apparatus 300 receives the data packets of the Stream Seq#0 to 3 normally in step S200. Therefore, the communication apparatus 300 discards the data packets of the Stream Seq#0 to 3 received in step S204.

The communication apparatus 300 receives the data packets of the Stream Seq#0 to 3 transmitted in step S204 (the processing of (1) (reception processing)) and determines the processing data from the received data packets of the Stream Seq#0 to 3 (the processing of (2) (determination processing of the processing data)), similar to step S106 illustrated in FIG. 4. FIG. 6 illustrates an example of the case in which the communication apparatus 300 can receive all of the data packets transmitted in step S204 normally.

In this case, the receiving apparatus 200A receives the data packets of the Stream Seq#0 to 3 normally in step S200. Therefore, the communication apparatus 300 discards the data packets of the Stream Seq#0 to 3 received in step S204.

The data packets (corresponding to the missing data) of the Stream Seq#1 and 2 not received normally in step S200 are received normally by the receiving apparatus 200A in step S204. Therefore, when the receiving apparatus 200A manages the processing data corresponding to the data packets of the Stream Seq#0 to 3 (the processing of (3) (processing for processing the processing data)), the receiving apparatus 200A completes the processing data corresponding to the data packets of the Stream Seq#1 and 2 not received normally in step S200 using the processing data corresponding to the data packets of the Stream Seq#1 and 2 received normally in step S204 and executes the processing.

The receiving apparatus 200B that has received the packets transmitted in step S204 can receive all of the data packets transmitted in step S206 normally. Therefore, the receiving apparatus 200B transmits a reply (for example, transmit a block ACK) indicating that the data packets have been received normally (S206).

If the reply is transmitted in step S206, the communication apparatus 300 receives the reply transmitted in step S206. The communication apparatus 300 can receive all of the data packets of the Stream Seq#0 to 3 transmitted from the transmitting apparatus 100 in steps S200 and S204 normally. However, the communication apparatus 300 does not transmit the reply to the external apparatuses such as the transmitting apparatus 100, the receiving apparatus 200A, and the receiving apparatus 200B.

If the reply transmitted in step S206 is received, the transmitting apparatus 100 transmits the data packets of the Stream Seq#1 and 2 in which retransmission is requested by the reply transmitted in step S202 to the receiving apparatus 200A (S208).

If the data packets of the Stream Seq#1 and 2 are transmitted in step S208, the receiving apparatus 200A receives the data packet of the Stream Seq#1 transmitted in step S104. FIG. 6 illustrates an example of the case in which the receiving apparatus 200A does not receive the data packet of the Stream Seq#1 transmitted in step S208 normally.

The communication apparatus 300 receives the data packets of the Stream Seq#1 and 2 transmitted in step S208 (the processing of (1) (reception processing)) and determines the processing data from the received data packet of the Stream Seq#1 (the processing of (2) (determination processing of the processing data)). FIG. 6 illustrates an example of the case in which the communication apparatus 300 can receive the data packets of the Stream Seq#1 and 2 transmitted in step S208 normally. In this case, the communication apparatus 300 receives the data packets of the Stream Seq#0 to 3 normally in step S200. Therefore, the communication apparatus 300 discards the received data packets of the Stream Seq#1 and 2 received in step S208.

The receiving apparatus 200A does not receive the data packet of the Stream Seq#1 normally in step S208. However, the receiving apparatus 200A receives the data packet of the Stream Seq#1 normally in step S204. Therefore, the receiving apparatus 200A transmits a reply (for example, transmit a block ACK) indicating that the data packet of the Stream Seq#1 has been received normally, even though the data packet of the Stream Seq#1 has not been received normally in step S208 (S210).

If the reply is transmitted in step S210, the communication apparatus 300 receives the reply transmitted in step S210. The communication apparatus 300 can receive all of the data packets of the Stream Seq#0 to 3 transmitted from the transmitting apparatus 100 in steps S200 and S204 normally. However, the communication apparatus 300 does not transmit a reply to the external apparatuses such as the transmitting apparatus 100, the receiving apparatus 200A, and the receiving apparatus 200B.

The communication system 1000 can execute the processing illustrated in FIG. 6. In the processing illustrated in FIG. 6, the communication apparatus 300 executes the processing of (1) (reception processing) to the processing of (3) (processing for processing the processing data) relating to the communication method according to the embodiment, similar to the processing illustrated in FIG. 4. Therefore, if the processing illustrated in FIG. 6 is executed, a communication system by which data can be stably received by a large number of apparatuses is realized.

In the processing illustrated in FIG. 6, the receiving apparatus 200A (first receiving apparatus) executes the processing of (1) (reception processing) to the processing of (3) (processing for processing the processing data) relating to the communication method according to the embodiment. As illustrated in step S210 of FIG. 6, the receiving apparatus 200A can transmit a reply (for example, transmit a block ACK) indicating that the retransmitted data packet of the Stream Seq#1 has been received normally, even when the retransmitted data packet of the Stream Seq#1 has not been received normally. As illustrated in FIG. 6, the receiving apparatus 200A (first receiving apparatus) executes the processing of (1) (reception processing) to the processing of (3) (processing for processing the processing data) relating to the communication method according to the embodiment and can decrease the frequency of retransmission of data in the unicast wireless communication. Therefore, as illustrated in FIG. 6, the receiving apparatus 200A (first receiving apparatus) executes the processing of (1) (reception processing) to the processing of (3) (processing for processing the processing data) relating to the communication method according to the embodiment and can improve transmission efficiency of data.

As illustrated with reference to FIGS. 4 and 6, the communication apparatus 300 forming the communication system 1000 illustrated in FIG. 3 executes the processing of (1) (reception processing) to the processing of (3) (processing for processing the processing data) relating to the communication method according to the embodiment and a communication system by which data can be stably received by a large number of apparatuses is realized.

The configuration of the communication system according to the embodiment is not limited to the configuration illustrated in FIG. 3. For example, FIG. 3 illustrates an example of the case in which the transmitting apparatus transmitting the transmission data using the first communication path is to the same as the transmitting apparatus transmitting the transmission data using the second communication path. However, the transmitting apparatus transmitting the transmission data using the first communication path may be different from the transmitting apparatus transmitting the transmission data using the second communication path.

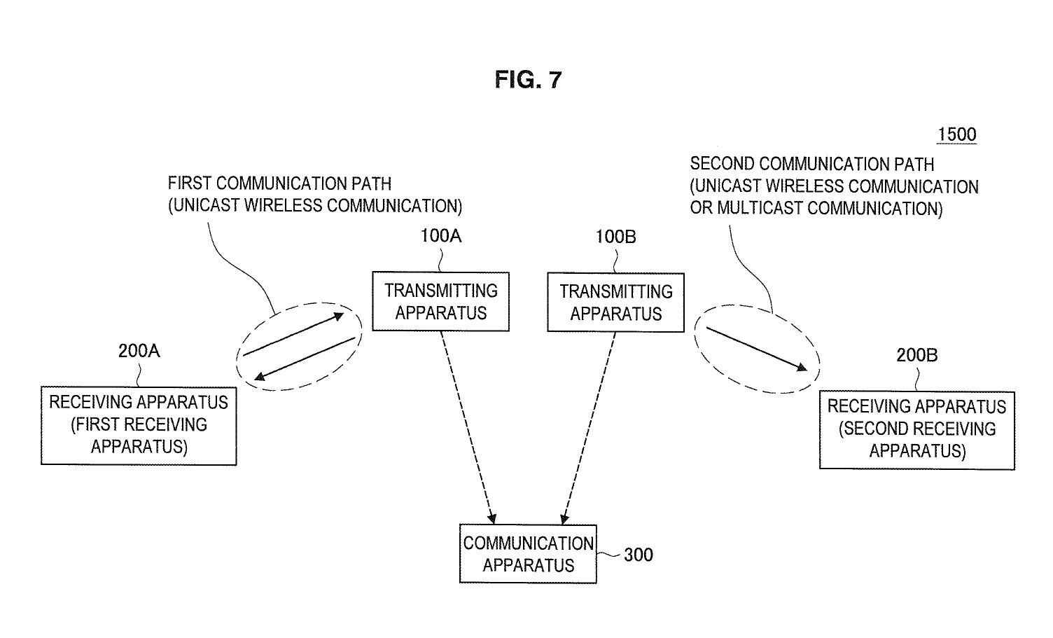

FIG. 7 is a diagram illustrating another example of the configuration of the communication system according to the embodiment. A communication system 1500 illustrated in FIG. 7 includes a transmitting apparatus 100A (first transmitting apparatus), a transmitting apparatus 100B (second transmitting apparatus), a receiving apparatus 200A (first receiving apparatus), a receiving apparatus 200B (second receiving apparatus), and a communication apparatus 300. In this case, the communication apparatus 300 is disposed to be located in communication areas of both the transmitting apparatus 100A and the transmitting apparatus 100B.

In this case, the receiving apparatus 200A (first receiving apparatus), the receiving apparatus 200B (second receiving apparatus), and the communication apparatus 300 that form the communication system 1500 illustrated in FIG. 7 have the same functions and configurations as the receiving apparatus 200A (first receiving apparatus), the receiving apparatus 200B (second receiving apparatus), and the communication apparatus 300 that form the communication system 1000 illustrated in FIG. 1.

The transmitting apparatus 100A wirelessly transmits transmission data to the receiving apparatus 200A (first receiving apparatus) through unicast. The transmitting apparatus 100B wirelessly transmits transmission data to the receiving apparatus 200B (second receiving apparatus) through unicast or multicast. The transmitting apparatus 100A may perform wired or wireless communication with the transmitting apparatus 100B and transmit the transmission data in a form of relaying the transmission data transmitted from the transmitting apparatus 100B. Likewise, the transmitting apparatus 100B may perform wired or wireless communication with the transmitting apparatus 100A and transmit the transmission data in a form of relaying the transmission data transmitted from the transmitting apparatus 100A.

As such, the communication apparatus 300 that forms the communication system 1500 has the same function and configuration as the communication apparatus 300 forming the communication system illustrated in FIG. 1. That is, the communication apparatus 300 that forms the communication system 1500 executes the processing of (1) (reception processing) to the processing of (3) (processing for processing the processing data) relating to the communication method according to the embodiment, similar to the communication apparatus 300 illustrated in FIG. 1. In this case, the communication apparatus 300 receives the first communication data transmitted and received using the first communication path and the second communication data transmitted and received using the second communication path and executes the processing. However, because the communication apparatus 300 determines the processing data using the specific identifier as described above, which apparatus the first communication data and the second communication data are transmitted from in practice is not a problem.

Because the communication apparatus 300 forming the communication system 1500 sets the transmission data transmitted from the transmitting apparatuses 100A and 100B as processing objects, the communication data transmitted from the transmitting apparatuses 100A and 100B may be received and the communication data transmitted from the receiving apparatuses 200A and 200B may not be received. The communication apparatus 300 that forms the communication system 1500 can execute the determination processing of the processing data and determine the processing data, similar to the communication apparatus 300 forming the communication system 1000 illustrated in FIG. 1. Therefore, even when the communication data transmitted from the receiving apparatus 200A or the receiving apparatus 200B is received, the determined processing data can be processed normally.

Therefore, the same processing as the processing illustrated in FIGS. 4 and 6 can be realized in the communication system 1500 illustrated in FIG. 7. Therefore, as illustrated in FIG. 7, even when there are a plurality of transmitting apparatuses, a communication system by which data can be stably received by a large number of apparatuses is realized.

### (Communication Apparatus According to Embodiment)

Next, an example of the configuration of the communication apparatus according to the embodiment that can execute the processing relating to the communication method according to the embodiment will be described. Hereinafter, the description is given mainly using the communication apparatus 300 forming the communication system 1000 illustrated in FIG. 1.

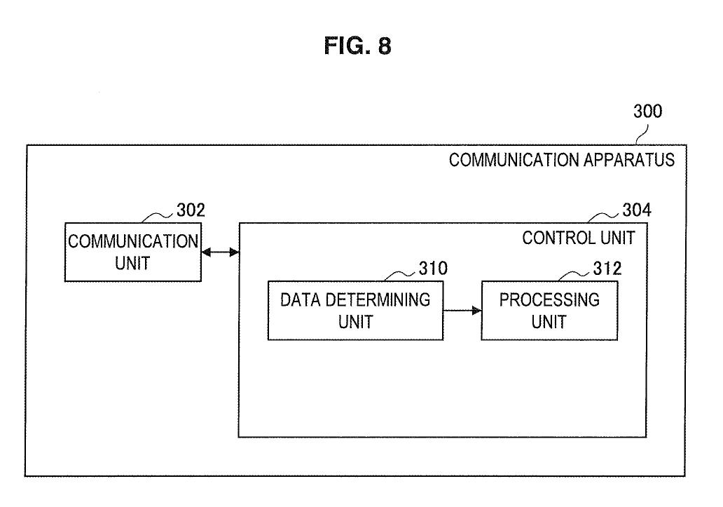

FIG. 8 is a block diagram illustrating an example of the configuration of the communication apparatus 300 according to the embodiment. The communication apparatus 300 includes a communication unit 302 and a control unit 304.

The communication apparatus 300 may include a read only memory (ROM) (not illustrated in the drawings), a random access memory (RAM) (not illustrated in the drawings), an operation unit (not illustrated in the drawings) that can be operated by a user, and a display unit (not illustrated in the drawings) that displays various screens on a display screen. The communication apparatus 300 connects the structural elements by a bus functioning as a transmission path of data.

The ROM (not illustrated in the drawings) stores control data such as programs or arithmetic parameters used by the control unit 304. The RAM (not illustrated in the drawings) temporarily stores the programs executed by the control unit 304. As the operation unit (not illustrated in the drawings), an operation device to be described below is exemplified. As the display unit (not illustrated in the drawings), a display device to be described below is exemplified.

### (Example of Hardware Configuration of Communication Apparatus 300)

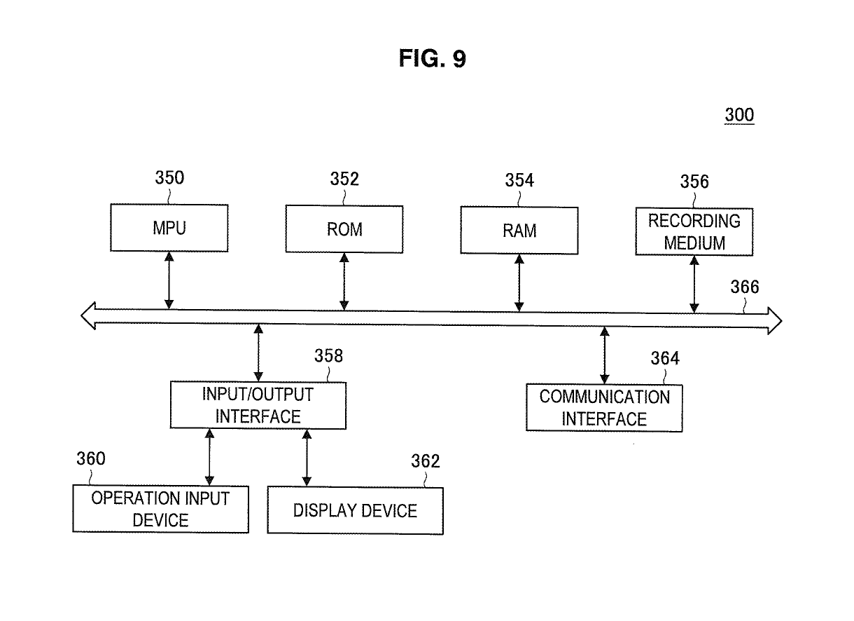

FIG. 9 is a diagram illustrating an example of a hardware configuration of the communication apparatus 300 according to the embodiment. The communication apparatus 300 includes an MPU 350, a ROM 352, a RAM 354, a recording medium 356, an input/output interface 358, an operation input device 360, a display device 362, and a communication interface 364. The communication apparatus 300 connects the structural elements by a bus 366 functioning as a transmission path of data.

The MPU 350 is configured using a micro processing unit or an integrated circuit in which various circuits to realize a control function are integrated and functions as a control unit 304 to control the entire communication apparatus 300. The MPU 350 functions as a data determining unit 310 and a processing unit 312 to be described below, in the communication apparatus 300.

The ROM 352 stores control data such as programs or arithmetic parameters used by the MPU 350 and the RAM 354 temporarily stores the programs executed by the MPU 350.

The recording medium 356 is a storage device included in the communication apparatus 300 and functions as the storage unit 104. For example, content data such as image data and an application are stored in the recording medium 356. In this case, a magnetic recording medium such as a hard disk and a nonvolatile memory such as a flash memory, a magnetoresistive random access memory (MRAM), and a ferroelectric random access memory (FeRAM) are exemplified as the recording medium 356. The recording medium 356 may be removed from the communication apparatus 300.

The input/output interface 358 connects the operation input device 360 and the display device 362. The operation input device 360 functions as an operation unit (not illustrated in the drawings) and the display device 362 functions as a display unit (not illustrated in the drawings). In this case, a universal serial bus (USB) terminal, a digital visual interface (DVI) terminal, a high-definition multimedia interface (HDMI) terminal, and various processing circuits are exemplified as the input/output interface 358. The operation input device 360 is provided on the communication apparatus 300 and is connected to the input/output interface 358 in the communication apparatus 300. As the operation input device 360, a button, a direction key, a rotary selector such as a jog dial, and a combination thereof are exemplified. The display device 362 is provided on the communication apparatus 300 and is connected to the input/output interface 358 in the communication apparatus 300. As the display device 362, a liquid crystal display (LCD), an organic electroluminescence display (organic EL display), and an organic light emitting diode display (OLED display) are exemplified. The input/output interface 358 can be connected to an operation input device (for example, a keyboard or a mouse) and a display device (for example, an external display) functioning as external devices of the communication apparatus 300. The display device 362 may be a device such as a touch screen in which display and a user operation are enabled.

The communication interface 364 is a communication device that is included in the communication apparatus 300 and functions as a communication unit 302 that performs wireless communication with the external apparatus through a network (or directly). In this case, an IEEE802.11n port, a transmitting/receiving circuit, a communication antenna, and a radio frequency (RF) circuit are exemplified as the communication interface 364. The communication interface 364 according to the embodiment is not limited thereto. For example, a device corresponding to an arbitrary communication system that can form a wireless communication network illustrated in FIG. 3 or 7 is exemplified as the communication interface 364.

The communication apparatus 300 executes the processing of (1) (reception processing) to the processing of (3) (processing for processing the processing data) relating to the communication method according to the embodiment, by the configuration illustrated in FIG. 9.

The configuration of the communication apparatus 300 according to the embodiment is not limited to the configuration illustrated in FIG. 9. For example, the communication apparatus 300 may further include one or more other communication devices that correspond to communication paths of observation objects other than the communication paths enabling reception of the communication data using the communication interface 364.

An example of the configuration of the communication apparatus 300 according to the embodiment will be described with reference to FIG. 8 again. The communication unit 302 is a unit performing a communication function that is included in the communication apparatus 300 and performs wireless communication with an external apparatus through a network (or directly). As the communication unit 302, an IEEE802.11n port, a transmitting/receiving circuit, a communication antenna, and a radio frequency (RF) circuit are exemplified. The communication unit 302 may be configured using a plurality of communication devices of the same kind of communication system and/or a different kind of communication system.

The communication unit 302 executes a part of the processing relating to the communication method according to the embodiment. Specifically, the communication unit 302 executes the processing of (1) (reception processing) and receives the communication data of the communication paths (in the case of the communication system 1000 illustrated in FIG. 3, the first communication path and the second communication path) of the observation objects.

In this case, as the communication data that is received by the communication unit 302, the transmission data obtained by alternately transmitting the application data frames to the receiving apparatus 200A (first receiving apparatus) and the receiving apparatus 200B (second receiving apparatus) for each frame by the transmitting apparatus 100, the reply data with respect to the transmission data, and the beacons are exemplified. The transmission data corresponding to each communication path that is received by the communication unit 302 may be transmitted from the same transmitting apparatus like the communication system 1000 illustrated in FIG. 3 or may be transmitted from the different transmitting apparatus like the communication system 1500 illustrated in FIG. 7.

The control unit 304 is configured using an MPU and controls the entire communication apparatus 300. The control unit 304 includes a data determining unit 310 and a processing unit 312 and leads the processing relating to the communication method according to the embodiment.

The data determining unit 310 leads the processing of (2) (processing for determining the processing data) and determines the processing data from the communication data received by the communication unit 302. For example, in the case of the communication system 1000 illustrated in FIG. 3, the data determining unit 310 determines the first processing data from the first communication data received by the communication unit 302 and determines the second processing data from the second communication data received by the communication unit 302.

Specifically, the data determining unit 310 detects a specific identifier from the received communication data and determines the communication data as the processing data, when the specific identifier is detected. In this case, the data determining unit 310 detects the SSRC field of the RTP header as the specific identifier. However, the specific identifier according to the embodiment is not limited thereto.

The data determining unit 310 does not determine the reply data such as the ACK or the NACK as the processing data. The data determining unit 310 may determine whether the transmission data is retransmitted on the basis of the reply data such as the ACK or the NACK received by the communication unit 302.

The data determining unit 310 discards the communication data (or a part of the communication data) received by the communication unit 302 or discards the communication data (or the part of the communication data) in other structural elements such as the communication unit 302, according to the determination result of the data. In this case, the data determining unit 310 discards the communication data that is not determined as the processing data. However, the communication data that is discarded by the data determining unit 310 is not limited thereto. For example, when the overlapped data is received due to the retransmission from the transmitting apparatus 100, the data determining unit 310 discards the communication data that corresponds to the overlapped data.

The data determining unit 310 does not make the communication unit 302 transmit a reply with respect to the external apparatuses such as the transmitting apparatus 100, the receiving apparatus 200A, and the receiving apparatus 200B, without depending on the determination result of the data.

The processing unit 312 leads the processing of (3) (processing for processing the processing data) and processes the processing data, which can be included in the received first communication data and second communication data, on the basis of the determination result of the data in the data determining unit 310.

Specifically, when there is missing data in either of the first processing data determined as the data used in the processing from the first communication data and the second processing data determined as the data used in the processing from the second communication data, the processing unit 312 replaces the missing data with the other processing data from which no data is missing and executes the processing. When there is processing data other than the first processing data and the second processing data, the processing unit 312 selectively performs the replacement using the processing data and executes the processing. When the processing unit 312 executes the processing, the processing unit 312 does not make the communication unit 302 transmit the reply with respect to the external apparatus such as the transmitting apparatus 100, the receiving apparatus 200A, and the receiving apparatus 200B.

In this case, the processing unit 312 complements the missing data by referring to the first processing data and the second processing data. However, the processing in the processing unit 312 is not limited thereto. For example, the processing unit 312 may use any one of the first processing data and the second processing data as main processing data mainly used in the processing and use the other processing data not to be the main processing data, only when there is missing data in the main processing data. If the processing unit 312 executes the processing concentrating on the main processing data received using the specific communication path, the processing unit 312 can further decrease the processing time of the processing of (3) (processing for processing the processing data), compared to when the processing unit 312 executes the processing concentrating on the processing data received using all of the communication paths.

As illustrated in FIG. 5, the processing unit 312 associates the MAC sequence numbers in the first communication data and the upper layer sequence numbers in the upper layers of the MAC layer and associates the MAC sequence numbers in the second communication data and the upper layer sequence numbers and executes the processing on the basis of the associations. In this case, the processing unit 312 can gather the association of the MAC layer sequence numbers and the upper layer sequence numbers in one queue and manage the first processing data and the second processing data (an example of the plurality of processing data), using an arbitrary method that can maintain the association of the MAC layer sequence numbers and the upper layer sequence numbers. In the communication apparatus 300 according to the embodiment, the association illustrated in FIG. 5 or the management in one queue may be executed by other structural elements such as the data determining unit 310.

For example, when the association illustrated in FIG. 5 is performed, the processing unit 312 may correct the association of the upper layer sequence numbers and the MAC sequence numbers in the first communication data when the data determining unit 310 determines the data not to be used in the processing from the received first communication data. Likewise, the processing unit 312 may correct the association of the upper layer sequence numbers and the MAC sequence numbers in the second communication data when the data determining unit 310 determines the data not to be used in the processing from the received second communication data. As such, the processing unit 312 can further decrease time necessary to execute the processing of (3) (processing for processing the processing data), by selectively correcting the association of the upper layer sequence number and the MAC sequence numbers in the first communication data and the association of the upper layer sequence numbers and the MAC sequence numbers in the second communication data.

The control unit 304 includes the data determining unit 310 and the processing unit 312 and leads the processing relating to the communication method according to the embodiment. The configuration for realizing the processing relating to the communication method according to the embodiment is not limited to the configuration of the control unit 304 illustrated in FIG. 8.

The communication apparatus 300 executes the processing (for example, the processing of (1) (reception processing) to the processing of (3) (processing for processing the processing data)) relating to the communication method according to the embodiment in the communication apparatus 300, by the configuration illustrated in FIG. 8. Therefore, the communication apparatus 300 that has the configuration illustrated in FIG. 8 is configured and a communication system by which data can be stably received by a large number of apparatuses can be realized.

The configuration of the communication apparatus 300 according to the embodiment is not limited to the configuration illustrated in FIG. 8. For example, the communication apparatus according to the embodiment may have a function of performing wireless communication with the transmitting apparatus 100 through unicast using the first communication path. When the communication apparatus according to the embodiment has the function of performing wireless communication with the transmitting apparatus 100 through unicast using the first communication path, the transmitting apparatus according to the embodiment can function as the first receiving apparatus in the communication system according to the embodiment. The communication apparatus according to the embodiment may have a function of performing wireless communication with the transmitting apparatus 100 using the second communication path. When the communication apparatus according to the embodiment has the function of performing wireless communication with the transmitting apparatus 100 using the second communication path, the communication apparatus according to the embodiment can function as the second receiving apparatus in the communication system according to the embodiment. That is, in the communication system according to the embodiment, the first receiving apparatus and/or the second receiving apparatus may function as the communication apparatus 300 that executes the processing relating to the communication method according to the embodiment.

The communication apparatus 300 has been described as the structural element forming the communication system according to the embodiment. The embodiment is not limited thereto. The embodiment can be applied to various apparatuses having a wireless communication function, for example, a computer such as a personal computer (PC) or a server, a portable communication apparatus such as a mobile phone or a personal handyphone system (PHS), a video/music reproducing apparatus, a video/music recording and reproducing apparatus, a game machine, and an imaging apparatus. The embodiment may be applied to a processing integrated circuit (IC) that executes the processing relating to the communication method according to the embodiment and may be embedded in the apparatuses having the wireless communication function.

The transmitting apparatus, the first receiving apparatus, and the second receiving apparatus have been described as the structural elements forming the communication system according to the embodiment. However, the embodiment is not limited thereto. The apparatuses can be applied to the various apparatuses having the wireless communication function, for example, the computer such as the PC or the server, the portable communication apparatus such as the mobile phone, the video/music reproducing apparatus, the video/music recording and reproducing apparatus, the game machine, and the imaging apparatus. The communication apparatus according to the embodiment may have a management function (access point (AP) function) based on a beacon.

### (Program According to Embodiment)

A communication system by which data can be stably received by a large number of apparatuses can be realized by a program (for example, a program for executing the processing relating to the communication method according to the embodiment, such as the processing of (1) (reception processing) to the processing of (3) (processing for processing the processing data)) for causing a computer to function as a the communication apparatus according to the embodiment.

It should be understood by those skilled in the art that various modifications, combinations, sub-combinations and alterations may occur depending on design requirements and other factors insofar as they are within the scope of the appended claims or the equivalents thereof.

In the above description, the program (computer program) for causing the computer to function as the communication apparatus according to the embodiment is provided. However, the embodiment can provide a recording medium storing the program.

The configuration described above is the example of the embodiment and belongs to a technical range of the present disclosure.

Additionally, the present technology may also be configured as below.

(1)

A communication apparatus including:

a communication unit that receives first communication data transmitted from a transmitting apparatus to a first receiving apparatus through unicast and second communication data transmitted from the transmitting apparatus to a second receiving apparatus, respectively; and

a processing unit that processes processing data, which can be included in the received first communication data and second communication data,

wherein, when there is missing data in either of first processing data included in the first communication data and second processing data included in the second communication data, the processing unit executes processing using the other processing data in which there is no missing data, and the processing unit does not make the communication unit transmit a reply with respect to external apparatuses.

(2)

The communication apparatus according to (1), further including:

a data determining unit that determines the processing data used in the processing from the received first communication data and second communication data,
wherein the processing unit processes the processing data determined as the data used in the processing.
   (3)

The communication apparatus according to (2),

wherein the data determining unit detects a specific identifier from the received communication data and determines the communication data as the processing data when the specific identifier is detected.

(4)

The communication apparatus according to (3),

wherein the specific identifier is a synchronization source (SSRC) field of a real-time transport protocol (RTP) header.

(5)

The communication apparatus according to any one of (1) to (4),

wherein the processing unit associates media access control address (MAC) sequence numbers in the first communication data and upper layer sequence numbers in upper layers of a MAC layer and associates MAC sequence numbers in the second communication data and the upper layer sequence numbers and executes the processing.

(6)

The communication apparatus according to (5),

wherein, when data not used in the processing is determined from the received first communication data, the processing unit corrects the association of the upper layer sequence numbers and the MAC sequence numbers in the first communication data, and

when data not used in the processing is determined from the received second communication data, the processing unit corrects the association of the upper layer sequence numbers and the MAC sequence numbers in the second communication data.

(7)

The communication apparatus according to any one of (1) to (6),

wherein the processing unit uses either of the first processing data and the second processing data as main processing data mainly used in the processing, and

the processing unit uses the other processing data not to be the main processing data, only when there is missing data in the main processing data.

(8)

The communication apparatus according to any one of (1) to (7),

wherein the processing unit manages the first processing data and the second processing data by one queue.

(9)

The communication apparatus according to any one of (1) to (8),

wherein the communication unit receives transmission data that is obtained by alternately transmitting data frames in which a plurality of data packets are coupled to the first receiving apparatus and the second receiving apparatus for each frame by the transmitting apparatus.

(10)

The communication apparatus according to any one of (1) to (9),

wherein the first receiving apparatus or the second receiving apparatus is a self apparatus.

(11)

The communication apparatus according to any one of (1) to (10),

wherein the first communication data that is transmitted to the first receiving apparatus through unicast is transmitted from a first transmitting apparatus, and

the second communication data that is transmitted to the second receiving apparatus is transmitted from a second transmitting apparatus different from the first transmitting apparatus.

(12)

A communication method including:

receiving first communication data transmitted from a transmitting apparatus to a first receiving apparatus through unicast and second communication data transmitted from the transmitting apparatus to a second receiving apparatus; and

processing processing data which can be included in the received first communication data and second communication data,

wherein, in the processing step, when there is missing data in either of first processing data included in the first communication data and second processing data included in the second communication data, processing is executed using the other processing data in which there is no missing data, and a reply with respect to external apparatuses is not transmitted.

(13)

A communication system including:

a transmitting apparatus;

a first receiving apparatus that communicates with the transmitting apparatus;

a second receiving apparatus that communicates with the transmitting apparatus; and

a communication apparatus that receives first communication data transmitted from the transmitting apparatus to the first receiving apparatus through unicast and second communication data transmitted from the transmitting apparatus to the second receiving apparatus, respectively,

wherein the communication apparatus includes a communication unit that receives the first communication data and the second communication data, respectively and a processing unit that processes processing data which can be included in the received first communication data and second communication data, and

when there is missing data in either of first processing data included in the first communication data and second processing data in the second communication data, the processing unit executes processing using the other processing data in which there is no missing data, and the processing unit does not make the communication unit transmit a reply with respect to external apparatuses.

The present disclosure contains subject matter related to that disclosed in Japanese Priority Patent Application JP 2011-116808 filed in the Japan Patent Office on May 25, 2011, the entire content of which is hereby incorporated by reference.

What is claimed is:

1. A communication apparatus comprising:
a communication unit that receives first communication data transmitted from a transmitting apparatus to a first receiving apparatus through unicast and second communication data transmitted from the transmitting apparatus to a second receiving apparatus, respectively; and
a processing unit that processes processing data which can be included in the received first communication data and second communication data,
wherein, when there is missing data in either of first processing data included in the first communication data and second processing data included in the second communication data, the processing unit executes processing using the other processing data in which there is no missing data, and the processing unit does not make the communication unit transmit a reply with respect to external apparatuses.

2. The communication apparatus according to claim 1, further comprising:
a data determining unit that determines the processing data used in the processing from the received first communication data and second communication data,
wherein the processing unit processes the processing data determined as the data used in the processing.

3. The communication apparatus according to claim 2,
wherein the data determining unit detects a specific identifier from the received communication data and determines the communication data as the processing data when the specific identifier is detected.

4. The communication apparatus according to claim 3,
wherein the specific identifier is a synchronization source (SSRC) field of a real-time transport protocol (RTP) header.

5. The communication apparatus according to claim 1,
wherein the processing unit associates media access control address (MAC) sequence numbers in the first communication data and upper layer sequence numbers in upper layers of a MAC layer and associates MAC sequence numbers in the second communication data and the upper layer sequence numbers and executes the processing.

6. The communication apparatus according to claim 5,
wherein, when data not used in the processing is determined from the received first communication data, the processing unit corrects the association of the upper layer sequence numbers and the MAC sequence numbers in the first communication data, and
when data not used in the processing is determined from the received second communication data, the processing unit corrects the association of the upper layer sequence numbers and the MAC sequence numbers in the second communication data.

7. The communication apparatus according to claim 1,
wherein the processing unit uses either of the first processing data and the second processing data as main processing data mainly used in the processing, and
the processing unit uses the other processing data not to be the main processing data, only when there is missing data in the main processing data.

8. The communication apparatus according to claim 1,
wherein the processing unit manages the first processing data and the second processing data by one queue.

9. The communication apparatus according to claim 1,
wherein the communication unit receives transmission data that is obtained by alternately transmitting data frames in which a plurality of data packets are coupled to the first receiving apparatus and the second receiving apparatus for each frame by the transmitting apparatus.

10. The communication apparatus according to claim 1,
wherein the first receiving apparatus or the second receiving apparatus is a self apparatus.

11. The communication apparatus according to claim 1,
wherein the first communication data that is transmitted to the first receiving apparatus through unicast is transmitted from a first transmitting apparatus, and
the second communication data that is transmitted to the second receiving apparatus is transmitted from a second transmitting apparatus different from the first transmitting apparatus.

12. A communication method comprising:
receiving first communication data transmitted from a transmitting apparatus to a first receiving apparatus through unicast and second communication data transmitted from the transmitting apparatus to a second receiving apparatus; and
processing processing data which can be included in the received first communication data and second communication data,
wherein, in the processing step, when there is missing data in either of first processing data included in the first communication data and second processing data included in the second communication data, processing is executed using the other processing data in which there is no missing data, and a reply with respect to external apparatuses is not transmitted.

13. A communication system comprising:
a transmitting apparatus;
a first receiving apparatus that communicates with the transmitting apparatus;
a second receiving apparatus that communicates with the transmitting apparatus; and
a communication apparatus that receives first communication data transmitted from the transmitting apparatus to the first receiving apparatus through unicast and second communication data transmitted from the transmitting apparatus to the second receiving apparatus, respectively,
wherein the communication apparatus includes a communication unit that receives the first communication data and the second communication data, respectively and a processing unit that processes processing data which can be included in the received first communication data and second communication data, and
when there is missing data in either of first processing data included in the first communication data and second processing data included in the second communication data, the processing unit executes processing using the other processing data in which there is no missing data, and the processing unit does not make the communication unit transmit a reply with respect to external apparatuses.
